(19) United States
(12) Patent Application Publication
(10) Pub. No.: US 2019/0281415 A1
(43) Pub. Date: Sep. 12, 2019

(54) GUIDANCE SYSTEM AND INFORMATION PROCESSING DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Eiji TOKITA, Ota Tokyo (JP); Satoshi KUMANO, Kawasaki Kanagawa (JP); Hiroshi KATAYAMA, Kawasaki Kanagawa (JP); Hiroki NISHIOKA, Fuchu Tokyo (JP)

(21) Appl. No.: 16/120,087

(22) Filed: Aug. 31, 2018

(30) Foreign Application Priority Data
Mar. 9, 2018 (JP) 2018-042828

(51) Int. Cl. H04W 4/024; H04W 4/02; G01S 1/02; G01S 5/00

(52) U.S. Cl. CPC H04W 4/024; G01S 5/0072; G01S 1/02; H04W 4/023

(57) ABSTRACT

A guidance system includes a portable terminal including a first communication device and a first controller configured to control the first communication device to transmit, to a first apparatus, a first signal including information about a current location of the portable terminal and a destination specified by a user. The first apparatus includes a second communication device and a second controller configured to control the second communication device to receive the first signal, determine one of second apparatuses located within a predetermined distance from the current location of the portable terminal and nearest to the destination, and control the second communication device to transmit, to the determined second apparatus, a second signal causing the second apparatus to transmit a beacon signal to the portable terminal. The portable terminal displays guidance information guiding the user toward the determined second apparatus based on the beacon signal.

### CROSS-REFERENCE TO RELATED APPLICATIONS

This application is based upon and claims the benefit of priority from Japanese Patent Application No. 2018-042828, filed Mar. 9, 2018, the entire contents of which are incorporated herein by reference.

### FIELD

Embodiments described herein relate generally to a guidance system and an information processing device.

### BACKGROUND

A guidance system is known that has a beacon-transmitting device that transmits a beacon in facilities and guides a user to the beacon-transmitting device using strength information of the beacon. However, in a case where a plurality of beacon-transmitting devices are provided, there is a possibility that it becomes difficult to determine which of the beacon-transmitting devices the user should select to further approach a destination.

### DESCRIPTION OF THE DRAWINGS

FIG. 1 is a diagram schematically illustrating the arrangement of a guidance system.

FIG. 2 is a block diagram illustrating a configuration of a mobile terminal.

FIG. 3 is a block diagram illustrating a configuration of a route information processing device.

FIG. 4 is a block diagram illustrating a configuration of a position information notification device.

FIG. 5 is a diagram illustrating an operation flow in a case where a user registers destination information on a mobile terminal.

FIG. 6 is a diagram illustrating an example of an operation flow in which a user holding the mobile terminal is guided.

FIG. 7 is a diagram schematically illustrating the arrangement of a guidance system according to a second embodiment.

FIG. 8 is a block diagram illustrating a configuration of a position information notification device according to the second embodiment.

FIG. 9 is a diagram illustrating an example of an operation flow in which the user is guided by using the position information notification device.

FIG. 10 is a diagram illustrating an example of an operation flow in which an operation of holding the mobile terminal is performed only for the first time.

FIG. 11 is a diagram illustrating an example of guidance of a first tag.

### DETAILED DESCRIPTION

Embodiments provide a guidance system and an information processing device capable of performing guidance by transmission control of a beacon.

In general, according to an embodiment, a guidance system comprises a portable terminal comprising a first communication device and a first controller configured to control the first communication device to transmit, to a first apparatus, a first signal including information about a current location of the portable terminal and a destination specified by a user of the portable terminal. The first apparatus comprises a second communication device and a second controller configured to control the second communication device to receive the first signal from the portable terminal, determine one of a plurality of second apparatuses located within a predetermined distance from the current location of the portable terminal and nearest to the destination, and control the second communication device to transmit, to the determined second apparatus, a second signal that causes the second apparatus to transmit a beacon signal to the portable terminal. The portable terminal displays guidance information that guides the user toward the determined second apparatus based on the beacon signal received from the determined second apparatus.

Hereinafter, an embodiment of the present disclosure will be described with reference to the drawings.

### First Embodiment

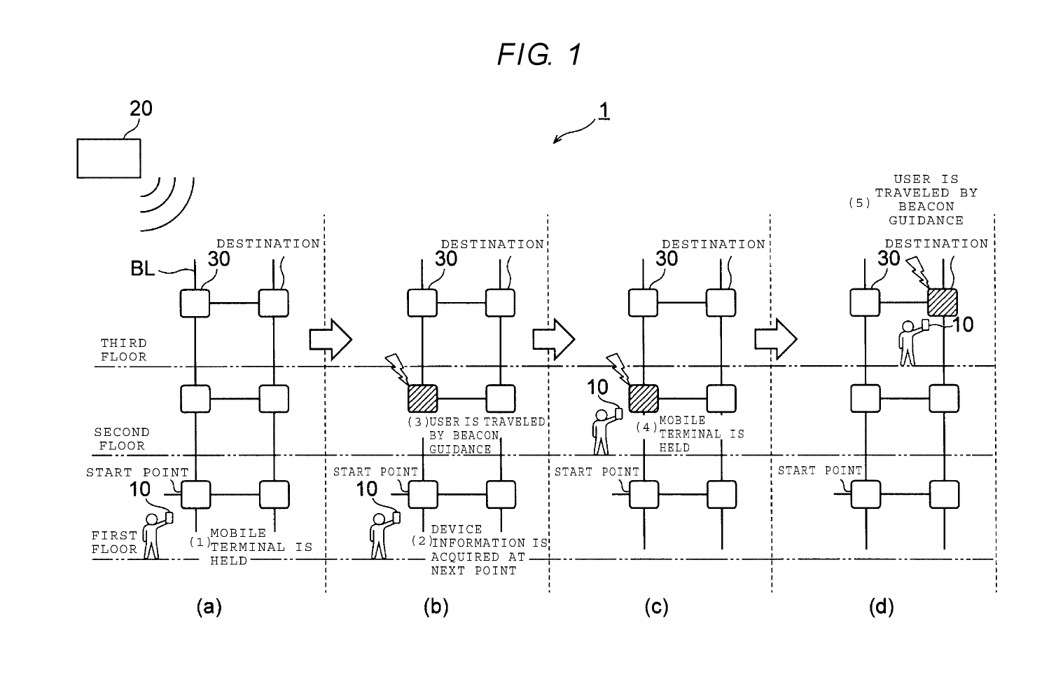

FIG. 1 is a diagram schematically illustrating arrangement of a guidance system 1. As described in FIG. 1, the guidance system 1 is a system relating to route guidance using wireless communication, and includes a mobile terminal 10 held by a user, a route information processing device 20 capable of communicating with the mobile terminal 10, and a plurality of the position information notification devices 30 disposed in plurality of predetermined positions. In addition, a line BL schematically indicates a search route used for calculating the shortest route from a start point to a destination. Notations (a), (b), (c), and (d) of FIG. 1 illustrate states in which a user holding the mobile terminal 10 is guided to the plurality of the position information notification devices 30 arranged along a route, in a chronological order of (a) to (d). In this manner, the user holding the mobile terminal 10 is guided by an order of beacons of the plurality of the position information notification devices 30 arranged along the route such that the user can reach the destination. Since the route guidance is performed regardless of a GPS or the like, three-dimensional guidance using an escalator and stairs in a building such as a department store is also possible.

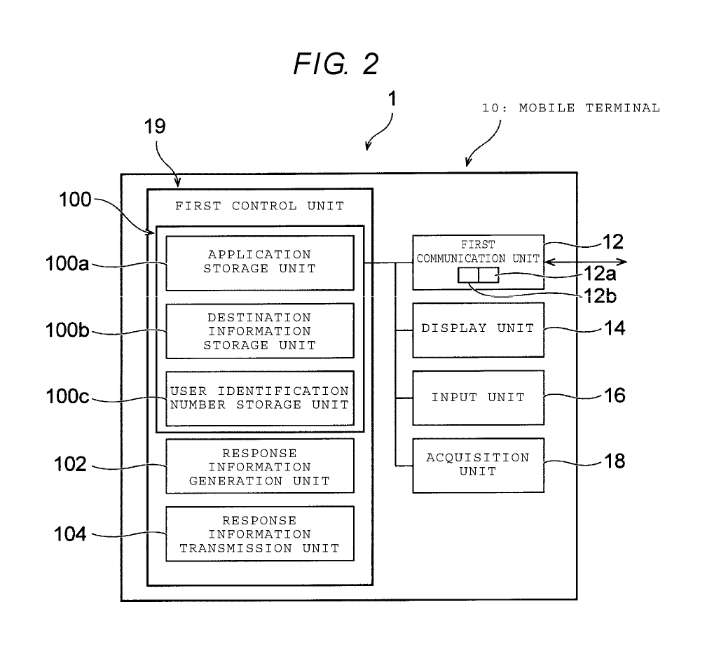

FIG. 2 is a block diagram illustrating a configuration of the mobile terminal 10. As described in FIG. 2, the mobile terminal 10 includes a first communication unit 12 (e.g., communication circuit), a display unit 14, an input unit 16, an acquisition unit 18 (e.g., Near Field Communication (NFC) or Radio Frequency Identification (RFID) reading/writing circuit), and a first control unit 19 (e.g., controller circuit). The mobile terminal 10 according to the present embodiment corresponds to a portable terminal.

The first communication unit 12 can communicate with the route information processing device 20 and the position information notification device 30. The first communication unit 12 includes an eleventh communication unit 12a and a twelfth communication unit 12b. For example, the eleventh communication unit 12a is a communication unit of performing the wireless communication with a base station corresponding to the current position of the mobile terminal 10. The eleventh communication unit 12a is used to access the route information processing device 20 via a network.

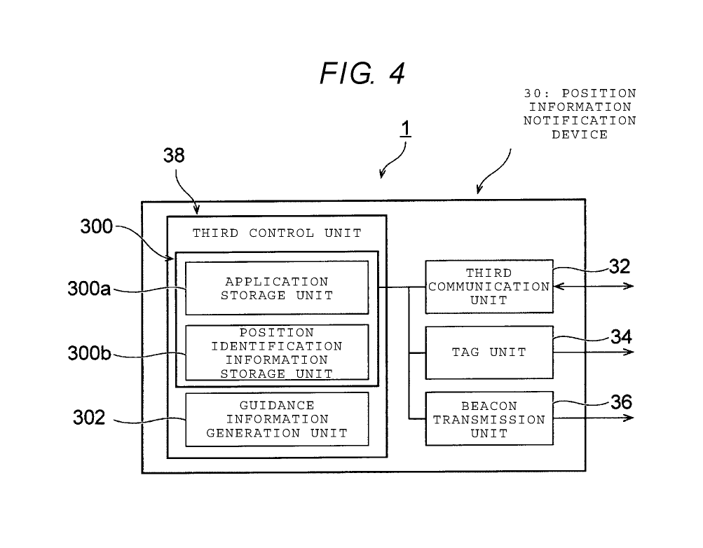

For example, the twelfth communication unit 12b establishes wireless connection with a beacon transmission unit 36 of the position information notification device 30 which will be described below (FIG. 4), by using a frequency hopping method, and receives the beacon. For example, the twelfth communication unit 12b receives the beacon at a time interval of 100 milliseconds.

For example, the display unit 14 is a liquid crystal display, and displays guidance information or the like to the user of the mobile terminal 10 under the control of the first control unit 19. The input unit 16 includes a touch panel, and is an interface of receiving an operation input performed by the user with respect to the mobile terminal 10. For example, the input unit 16 receives destination information and user identification number by an operation of a user.

The acquisition unit 18 acquires position information relating to the current position from a tag capable of performing proximity wireless communication. For example, the acquisition unit 18 includes a reader for reading the tag such as an IC tag, and acquires the position information relating to the current position from the tag of the position information notification device 30. More specifically, the acquisition unit 18 acquires a position identification number indicating a position of the position information notification device 30 from the tag. The position identification number is associated with the position information, for example, latitude and longitude, and centrally managed within the guidance system 1. The tag is not limited to the IC tag, and may be a near field communication (NFC) tag or the like. In addition, the IC tag according to the present embodiment may be an active tag that emits radio waves with its own power during communication or a passive tag that operates using radio waves from a reader as an energy source.

The first control unit 19 is a control unit or a control circuit that executes an application software, and includes a central processing unit (CPU). The first control unit 19 includes a first storage unit 100, a response information generation unit 102, and a response information transmission unit 104.

For example, the first storage unit 100 includes a read-only memory (ROM), a random access memory (RAM), or the like, and includes an application storage unit 100a, a destination information storage unit 100b, and a user identification number storage unit 100c. There is a storage area of storing a plurality of application programs for realizing a predetermined function in the mobile terminal 10 in the application storage unit 100a. In the guidance system according to the present embodiment, by performing a guidance application stored in the application storage unit 100a, it is possible to realize a function of the mobile terminal 10 according to the present embodiment.

The destination information storage unit 100b is a storage area of storing the identification number of the destination. For example, the route information processing device 20 issues the position identification number of the position information notification device 30 corresponding to the destination input by the user from the input unit 16 as the identification number of the destination.

The user identification number storage unit 100c is a storage area of storing the user identification number of the mobile terminal 10. For example, the user identification number storage unit 100c stores the user identification number input by the user through the input unit 16. The guidance application may issue the user identification number.

The response information generation unit 102 generates a response signal including the position information relating to the current position acquired from the tag by the acquisition unit 18, for example, the position identification number, the destination information, and the user identification number. In addition, the response information generation unit 102 allows a display unit to display the guidance information based on the beacon. For example, the response information generation unit 102 allows the display unit 14 to display a distance to the position information notification device 30 as the guidance information according to intensity of the beacon issued by the position information notification device 30.

In addition, the response information generation unit 102 allows the display unit 14 to display the position information of the position information notification device 30 along a route which is received from the route information processing device 20 (which will be described below) as the guidance information. In this case, the display unit 14 may display positions of map information and the position information notification device 30 along the route received from the route information processing device 20. The response information generation unit 102 according to the present embodiment corresponds to the display control unit.

The response information transmission unit 104 transmits the response signal generated by the response information generation unit 102 to the route information processing device 20 by the eleventh communication unit 12a.

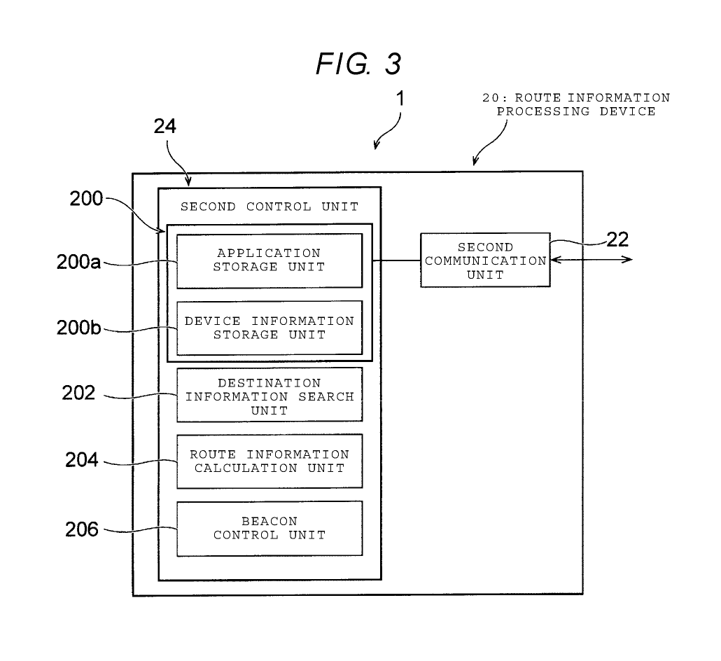

FIG. 3 is a block diagram illustrating a configuration of the route information processing device 20. As described in FIG. 3, the route information processing device 20 includes a second communication unit 22 and a second control unit 24. The route information processing device 20 according to the present embodiment corresponds to the information processing device.

The second communication unit 22 communicates with the mobile terminal 10 and the plurality of the position information notification devices 30. The second communication unit 22 is the communication unit of performing the wireless communication with the base station corresponding to the position of the route information processing device 20. For example, the second communication unit 22 is used for communicating with the mobile terminal 10 and the position information notification device 30 via a network.

The second control unit 24 is a control unit of executing guidance application software of a route information processing device 20 side, and includes a central processing unit (CPU). The second control unit 24 includes a second storage unit 200, a destination information search unit 202, a route information calculation unit 204, and a beacon control unit 206.

For example, the second storage unit 200 is configured to include a read-only memory (ROM) and a random access memory (RAM), and includes an application storage unit 200a and a device information storage unit 200b. The guidance application of the route information processing device 20 side is stored in the application storage unit 200a. In the guidance system according to the present embodiment, by performing the guidance application stored in the application storage unit 200a, it is possible to realize a function according to the route information processing device 20.

The device information storage unit 200b stores positions of the plurality of the position information notification devices 30 capable of issuing the beacon. More specifically, the device information storage unit 200b stores the position identification number allocated to each of the plurality of the position information notification devices 30. For example, the device information storage unit 200b stores information obtained by associating the position identification number with information of longitude and latitude.

The destination information search unit 202 searches for the position of the position information notification device 30 corresponding to the destination included in the destination information received from the mobile terminal 10 from the information stored in the device information storage unit 200b. More specifically, the destination information search unit 202 searches for the position identification number of the position information notification device 30 closest to the destination, and transmits the searched position identification number to the mobile terminal 10 by the second communication unit 22.

The route information calculation unit 204 acquires the position information of the position information notification devices 30 arranged along a route from the current position of the mobile terminal 10 to the destination from the plurality of the position information notification devices stored in the device information storage unit 200b, based on the position information received from the mobile terminal 10 and the destination information. For example, the route information calculation unit 204 calculates the shortest route via the position information notification devices 30 arranged from the current position to the destination, and acquires the position information of the position information notification devices 30 arranged along the shortest route. The route information calculation unit 204 calculates the shortest route from the route BL (FIG. 1) which can be combined by an algorithm for solving a general optimization problem. That is, in calculating the shortest route, information such as walls in the facility, a passage connecting upper and lower stories such as stairs and escalators, and the like are taken into consideration. These types of information are stored in the device information storage unit 200b together with the map information.

In addition, the route information calculation unit 204 selects the position information notification device 30 closest to the current position from the position information notification devices 30 arranged along the route from the current position of the destination, and outputs the information of the selected position information notification device 30 to the beacon control unit 206. That is, the route information calculation unit 204 selects the position information notification device 30 disposed in a position in which a distance to the destination is shorter than that of the current position to the destination, and outputs the information of the selected position information notification device 30 to the beacon control unit 206 based on the information of the current position of the mobile terminal 10 and the destination information.

In addition, the route information calculation unit 204 transmits the position information of the position information notification devices 30 arranged along the route from the current position to the destination to the mobile terminal 10. More specifically, the route information calculation unit 204 transmits the position identification number of the position information notification devices 30 arranged along the route from the current position to the destination to the mobile terminal 10. With this, as described above, the display unit of the mobile terminal 10 can display the position information of the position information notification devices arranged along the route from the current position to the destination as the guidance information. The route information calculation unit 204 according to the present embodiment corresponds to a route information acquisition unit.

The beacon control unit 206 performs transmission control in which the beacon is transmitted to the position information notification device 30 based on information input from the route information calculation unit 204. For example, the beacon control unit 206 performs the transmission control of the beacon with respect to at least one of the position information notification devices 30 of which the position information is acquired by the route information calculation unit 204. More specifically, the beacon control unit 206 performs the transmission control in which the beacon is transmitted to the position information notification device 30 selected from the position information notification devices 30 arranged along the route from the current position to the destination, which is acquired by the route information calculation unit 204.

For example, the beacon control unit 206 transmits the beacon to the position information notification device 30 in the vicinity of the current position of the mobile terminal 10, that is, disposed in a position where a distance of a movement route to the destination is shorter among the position information notification devices 30 in a predetermined distance range from the current position. Here, as described above, the selection of the position information notification device 30 in the vicinity of the mobile terminal 10 is performed by taking into consideration the distance of a movement route to the destination, and the information such as walls in the facility, a passage connecting upper and lower stories such as stairs and escalators. Therefore, for example, even if a position information notification device 30 that physically (communication distance) is closest to the mobile terminal 10 separated from the wall, when considering a distance of the movement route until reaching the position separated by the wall, if the distance of the movement route to the destination in another position information notification device 30 present in the vicinity of the mobile terminal 10 is shorter, another position information notification device 30 is selected. With this, when reaching the position information notification device 30 transmitting the beacon according to the guidance information of the mobile terminal 10, the user holding the mobile terminal 10 can approach the destination rather than the current position.

In addition, the beacon control unit 206 performs an operation by which the beacon including information of the user identification number received from the mobile terminal 10 is transmitted to the position information notification device 30. With this, even in a case where a plurality of the mobile terminals 10 having the same guidance application are present, mixing of the beacons is avoided.

FIG. 4 is a block diagram illustrating a configuration of the position information notification device 30. As described in FIG. 4, the position information notification device 30 includes a third communication unit 32, a tag unit 34, the beacon transmission unit 36, and a third control unit 38. The position information notification device 30 according to the present embodiment corresponds to a beacon-transmitting device.

The third communication unit 32 communicates with the mobile terminal 10 and the position information notification device 30. The third communication unit 32 is the communication unit of performing the wireless communication with the base station according to the position of the position information notification device 30.

A tag capable of performing short-range wireless communication is provided in the tag unit 34. For example, tag is a tag capable of performing the short-range wireless communication such as the IC tag. A signal including the position information relating to the current position in the mobile terminal 10 is transmitted to the tag unit 34. For example, the tag unit 34 transmits a signal including the position identification number allocated to the position information notification device 30 to the mobile terminal 10. With this, it is possible to acquire information of the current position of the mobile terminal 10 without using GPS or the like. As described above, the tag is not limited to the IC tag, and may be an NFC tag or the like. In addition, the tag may supply additional information such as facility and store information and advertisement information in the vicinity of the position information notification device 30 together with the position identification number. With this, the facility and store information and the advertisement information in the vicinity of the current position can be displayed on the display unit 14 of the mobile terminal 10.

The beacon transmission unit 36 transmits the beacon including the identification number of the mobile terminal 10 transmitted by the route information processing device 20. For example, the beacon transmission unit 36 establishes wireless connection to the twelfth communication unit 12b of the mobile terminal 10, and continuously transmits the beacon at a predetermined interval, by using the frequency hopping method.

The third control unit 38 is a control unit of executing the guidance application software of a position information notification device 30 side, and includes a central processing unit (CPU). The third control unit 38 includes a third storage unit 300 and a guidance information generation unit 302.

For example, the third storage unit 300 includes the read-only memory (ROM) and the random access memory (RAM), and includes an application storage unit 300a and a position identification number storage unit 300b. The guidance application of the position information notification device 30 side is stored in the application storage unit 300a. In the guidance system according to the present embodiment, by performing the guidance application stored in the application storage unit 300a, it is possible to realize a function of the position information notification device 30. The position identification number storage unit 300b stores a position identification number for identifying the position of the position information notification device 30. A unique position identification number is stored in the position identification number storage unit 300b of each of the plurality of the position information notification devices 30.

The guidance information generation unit 302 generates beacon information. More specifically, the beacon information including the user identification number of the mobile terminal 10 of a guidance target received from the route information processing device 20 is generated. The guidance information generation unit 302 transmits the generated beacon information by the beacon transmission unit 36.

The above is the description of the configuration of the guidance system 1 according to the present embodiment. Next, an operation example of the guidance system 1 will be described.

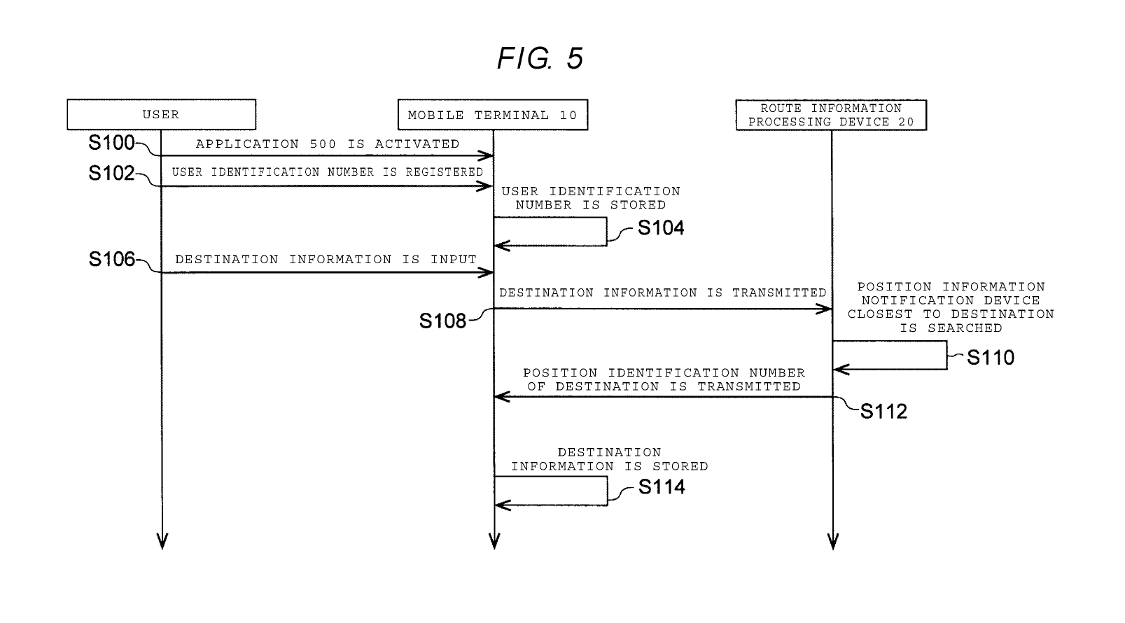

First, based on FIG. 5, setting of the user identification number and the position identification number of the destination will be described. FIG. 5 is a diagram illustrating an operation flow in a case where the user identification number and the position identification number of the destination are registered in the mobile terminal 10. As described in FIG. 5, first, the user activates the guidance application by the input unit 16 of the mobile terminal 10 (step S100). Next, the user performs a registration operation of the user identification number by using the input unit 16 (step S102), and the user identification number storage unit 100c stores the user identification number (step S104). The user identification number may be automatically created at the time of activating the guidance application.

Next, the user inputs the destination through the input unit 16 (step S106), and the eleventh communication unit 12a transmits a signal including information of the destination to the route information processing device 20 (step S108).

Next, the destination information search unit 202 of the route information processing device 20 searches for the input destination or the position information notification device 30 closest to the destination, based on a signal received from the mobile terminal 10 (step S110). Subsequently, the destination information search unit 202 transmits a signal including the searched position identification number of the position information notification device 30 to the mobile terminal 10 (step S112). In this manner, the position information of the position information notification device 30 is centrally managed by the route information processing device 20.

The mobile terminal 10 registers the received position identification number in the destination information storage unit 100b of the mobile terminal 10 (step S114). In this manner, by an input operation for the mobile terminal 10 by the user, the user identification number and the position identification number of the destination are set in the destination information storage unit 100b and the user identification number storage unit 100c of the mobile terminal 10, respectively.

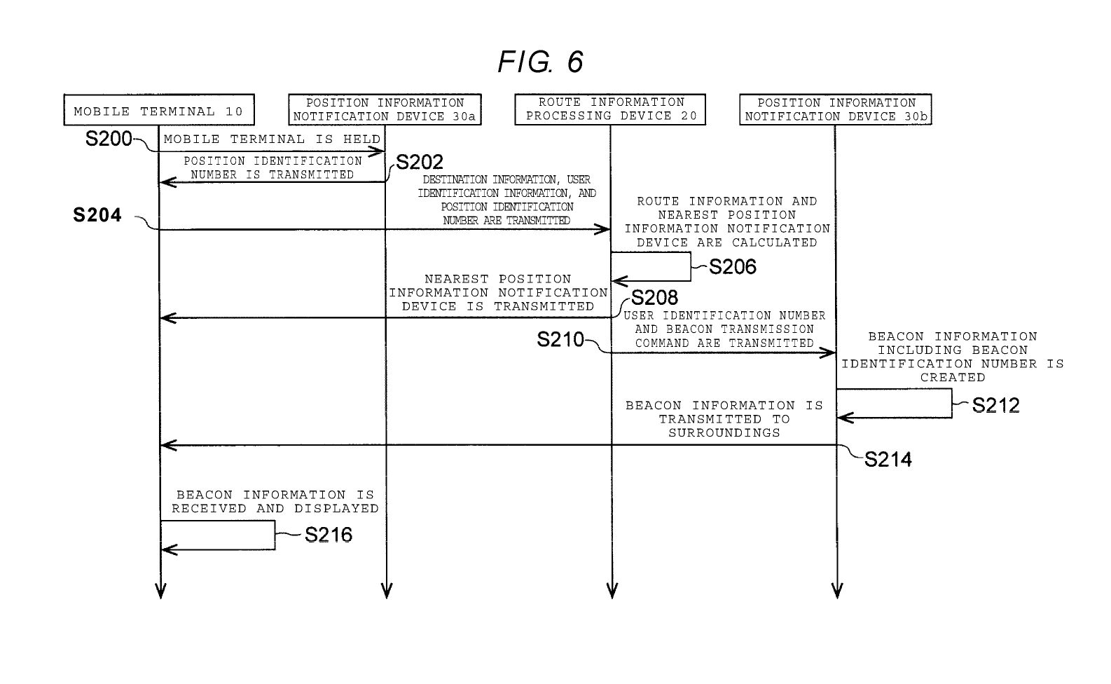

Next, an operation example guiding the user holding the mobile terminal 10 will be described based on FIG. 6. FIG. 6 is an example of an operation flow in which the user holding the mobile terminal 10 is guided by using the route information processing device 20. Here, the plurality of the position information notification devices 30 are distinguished from each other by adding a and b. As described in FIG. 6, first, the user holds the mobile terminal 10 over the tag unit 34 of the position information notification device 30a, that is, bring it close to the tag unit 34 (step S200).

Next, the tag unit 34 of the position information notification device 30a transmits a signal including the position identification number of the position information notification device 30a to the acquisition unit 18 of the mobile terminal 10 (step S202). With this, the acquisition unit 18 acquires the position information relating to the current position.

Next, the response information generation unit 102 of the mobile terminal 10 generates the response information including the position identification number of the destination, the user identification number, and the received position identification number of the current position, set in the mobile terminal 10 in advance. The response information transmission unit 104 of the mobile terminal 10 transmits the response signal including the response information to the route information processing device 20 by the eleventh communication unit 12a (step S204).

Next, the route information calculation unit 204 of the route information processing device 20 acquires installation information of the plurality of the registered position information notification devices 30 from the device information storage unit 200b, and calculates the position information notification device 30b closest to the mobile terminal 10 in the route from the current position of the mobile terminal 10 to the destination (step S206).

Next, the route information processing device 20 transmits the position identification number of the position information notification device 30b closest to the current position to the mobile terminal 10 by the second communication unit 22 (step S208). With this, the position information of the position information notification device 30b received from the route information processing device 20 is displayed on the display unit 14 of the mobile terminal 10.

In addition, the beacon control unit 206 of the route information processing device 20 transmits the user identification number of the mobile terminal 10 and a beacon transmission command to the position information notification device 30b (step S210). Subsequently, when the position information notification device 30b receives the beacon transmission command, the guidance information generation unit 302 creates the beacon information including the user identification number (step S212), and transmits the created information from the beacon transmission unit 36 to the surroundings (step S214).

Next, when the mobile terminal 10 receives the beacon information including the user identification number of the mobile terminal 10, a response information generation unit 102 of the mobile terminal 10 generates the guidance information including information indicating that the beacon information is received and distance information according to reception strength of the beacon emitted from the position information notification device 30b, and displays the generated information on the display unit 14 (step S216). With this, the user holding the mobile terminal 10 is guided to a route for the position information notification device 30b according to the guidance information displayed on the display unit 14 of the mobile terminal 10. By repeating such processes, the user holding the mobile terminal 10 is guided to the destination.

In this manner, the route information calculation unit 204 of the route information processing device 20 performs an operation by which the position information notification device 30b closest to the mobile terminal 10 in the route from the current position to the destination is calculated and the beacon is transmitted. With this, the user holding the mobile terminal 10 is guided to a position closer to the destination than the current position according to the beacon information received by the mobile terminal 10.

As described above, according to the embodiment, the mobile terminal 10 transmits the signal including the information of the current position of the mobile terminal 10 and the destination information to the route information processing device 20, and the route information processing device 20 transmits the beacon to the position information notification device 30 of the position closer to the destination than the current position based on the current position and the destination. With this, it is possible to guide the user of the mobile terminal 10 to the position closer to the destination than the current position.

### Second Embodiment

The position information notification device 30 according to the present embodiment is different from the position information notification device 30 according to the first embodiment in that the present embodiment has a function of acquiring a route to the destination. Hereinafter, differences from the first embodiment will be described.

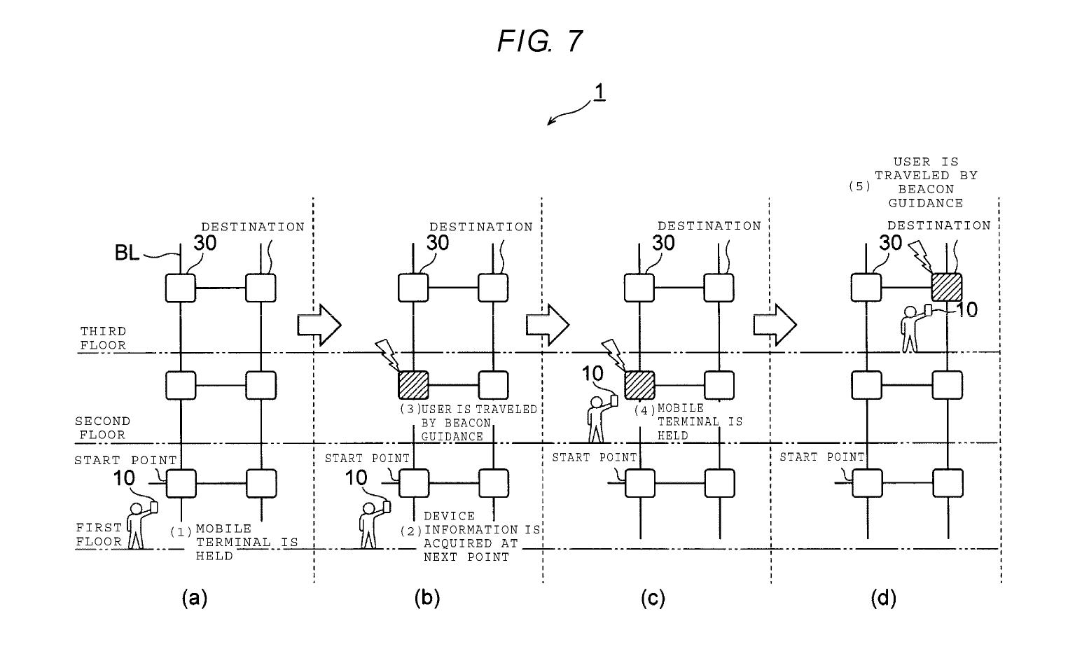

FIG. 7 is a diagram schematically illustrating the arrangement of a guidance system 1 according to a second embodiment. As described in FIG. 7, the guidance system 1 according to the second embodiment is a system relating to the route guidance using the wireless communication, and includes the mobile terminal 10 and the plurality of the position information notification devices 30.

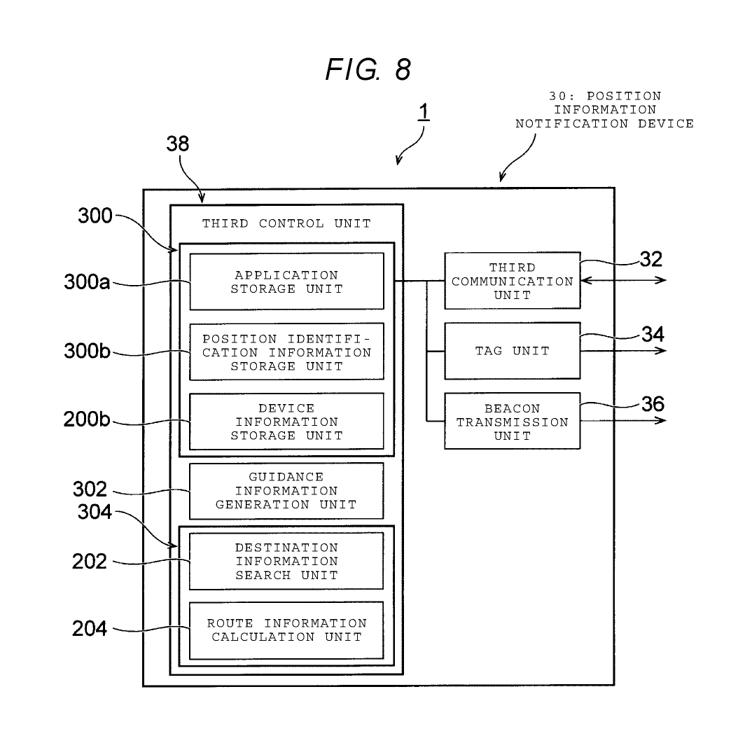

FIG. 8 is a block diagram illustrating a configuration of the position information notification device 30 according to the second embodiment. As described in FIG. 8, in that the position information notification device 30 according to the second embodiment further includes the device information storage unit 200b and a route information supply unit 304, the position information notification device 30 according to the second embodiment is different from the position information notification device 30 according to the first embodiment.

The route information processing device 20 side and the guidance application of the position information notification device 30 side are stored in the application storage unit 300a. In the guidance system according to the present embodiment, by performing the guidance application stored in the application storage unit 300a, it is possible to realize functions of the route information processing device 20 and the position information notification device 30. That is, the route information supply unit 304 includes the destination information search unit 202 and the route information calculation unit 204. The guidance information generation unit 302 according to the present embodiment corresponds to the beacon control unit and the third communication unit 32 corresponds to the second communication unit.

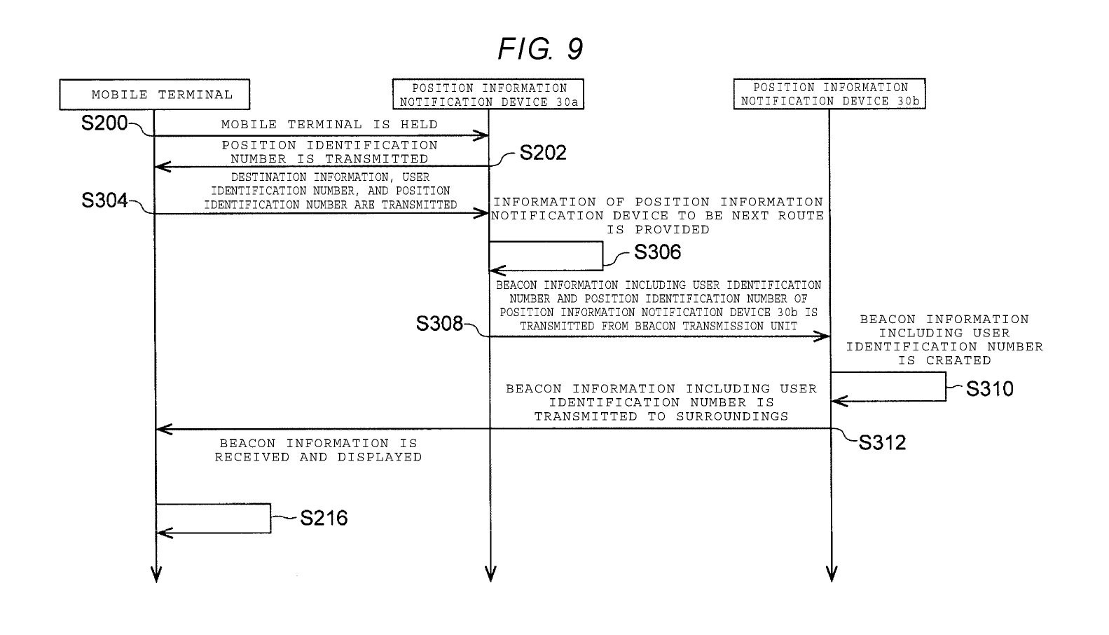

FIG. 9 is a diagram illustrating an example of an operation flow in which the user holding the mobile terminal 10 is guided by using the position information notification device 30. Here, the plurality of the position information notification devices 30 are distinguished from each other by adding a and b. In addition, operation examples the same as those in FIG. 7 are denoted by the same reference numerals, and description thereof is omitted.

As described in FIG. 9, after performing the same processes as processes from step S200 to step S202 (FIG. 6), the response information generation unit 102 of the mobile terminal 10 generates the response information including a purpose identification number set in the mobile terminal 10 in advance, the user identification number, and the position identification number. The response information transmission unit 104 of the mobile terminal 10 transmits the response signal including the response information to the position information notification device 30a by the eleventh communication unit 12a (step S304).

Next, the route information calculation unit 204 of the position information notification device 30a acquires the installation information of the registered position information notification device from the device information storage unit 200b, and calculates the position information notification device 30b closest to the mobile terminal 10 along the route from the current position of the mobile terminal 10 to the destination (step S306).

Next, in the guidance information generation unit 302 of the position information notification device 30a, the beacon information including the position identification number of the position information notification device 30b and the user identification number is generated and the generated information is transmitted from the beacon transmission unit 36 to the surroundings (step S308).

Next, when the position identification number of the position information notification device 30b is included in the beacon information received by the position information notification device 30b, the guidance information generation unit 302 of the position information notification device 30b generates the beacon information including the user identification number (step S310), and transmits the generated information from the beacon transmission unit 36 of the position information notification device 30b to the surroundings (step S312). The mobile terminal 10 performs the same process as that of step S216. By repeating such a process, the user holding the mobile terminal 10 is guided to the destination.

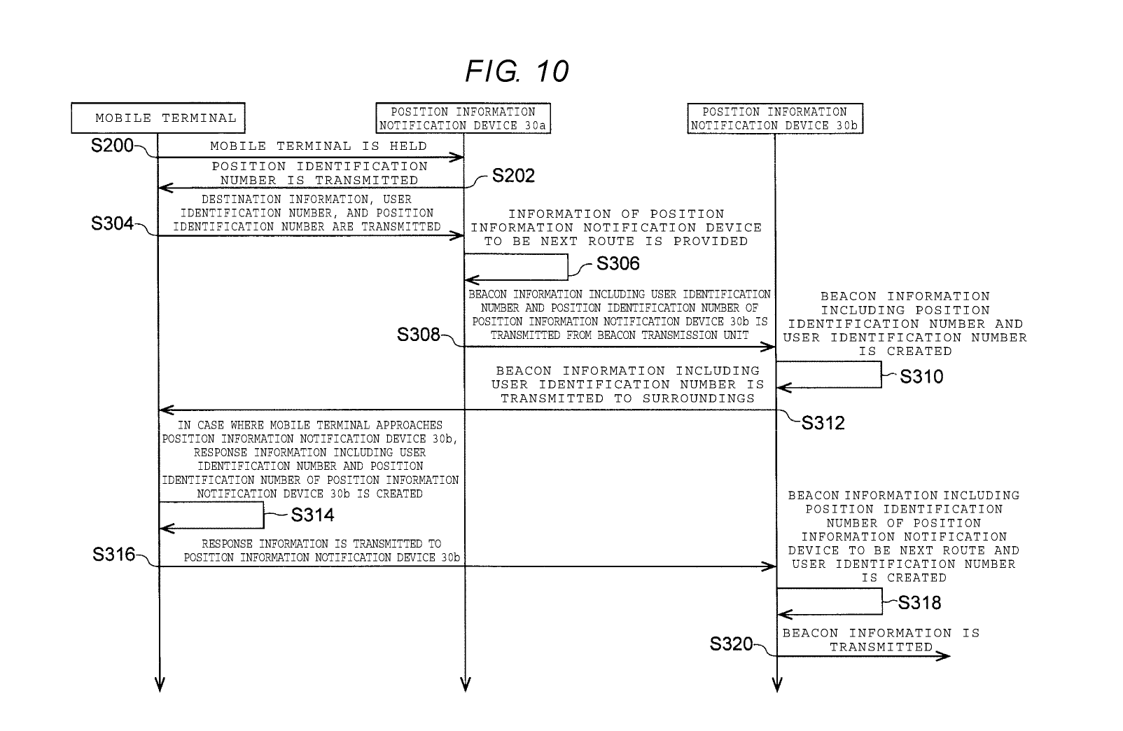

FIG. 10 is a diagram illustrating an example of an operation flow in which an operation of holding the mobile terminal 10 is performed only for the first time. Here, the plurality of the position information notification devices 30 are distinguished from each other by adding a and b. In addition, operation examples the same as those in FIG. 9 are denoted by the same reference numerals, and description thereof is omitted.

First, processes from step S200 to step S312 are performed similar to those in FIG. 9. Next, the response information generation unit 102 of the mobile terminal 10 determines that the mobile terminal 10 approaches the position information notification device 30b by a predetermined distance by radio wave intensity of the received beacon, and creates the response information including the user identification number of the mobile terminal 10 and the position identification number of the position information notification device 30b (step S314). Subsequently, the response information transmission unit 104 transmits a signal including the response information to the plurality of the position information notification devices 30 by the eleventh communication unit 12a (step S316).

The position information notification device 30b receives the response information transmitted by the mobile terminal 10, and in a case where the position identification number of the position information notification device 30b is included in the received response information, the route information calculation unit 204 of the position information notification device 30b calculates a position of the position information notification device 30 to be the next route. The guidance information generation unit 302 of the position information notification device 30b creates the beacon information including the position identification number of the position information notification device 30c to be the next route and the user identification number (step S318), and transmits the created information from the beacon transmission unit 36 to the surroundings (step S320). In this manner, by repeating the operation, the user is guided to the destination without holding the mobile terminal over the position information notification device except for the first holding operation. In this manner, by the beacon communication between the plurality of the position information notification devices 30, the next position information notification device 30 on the route transmits the beacon. It is possible to perform the beacon communication between adjacent position information notification devices 30, and it is possible to control the beacon even in poor wireless environment.

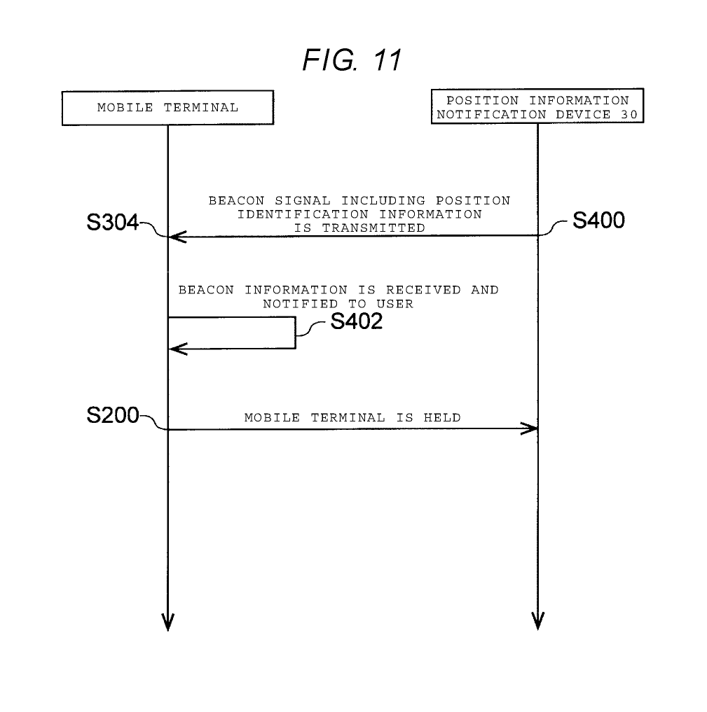

FIG. 11 is a diagram illustrating a guidance example of the first tag. As described in FIG. 11, the guidance information generation unit 302 of the position information notification device 30 creates the beacon information including the position identification number of the position information notification device 30, and transmits the created information from the beacon transmission unit 36 to the surroundings (step S400).

Next, when the mobile terminal 10 receives the beacon information not including the user identification number of the mobile terminal 10, the response information generation unit 102 generates information indicating that the beacon information is received and the position information according to the intensity of the beacon information transmitted by the position information notification device 30, and allows the display unit 14 to display the generated information (step S402). With this, the user holding the mobile terminal 10 is guided based on the beacon information received in the mobile terminal 10 to the route for the position information notification device 30. With this, the user can hold the mobile terminal 10 over the tag unit 34 of the position information notification device 30 (step S200).

As described above, according to the embodiment, the position information notification device 30 includes the route information calculation unit 204. With this, the position information notification device 30a can transmit the beacon to the position information notification device 30b at a position closer to the destination than the current position. Therefore, it is possible to perform the beacon communication for beacon control between the adjacent position information notification devices 30, and it is possible to control the beacon even in poor wireless environment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A guidance system comprising:
a portable terminal comprising:
a first communication device; and
a first controller configured to
control the first communication device to transmit, to a first apparatus, a first signal including information about a current location of the portable terminal and a destination specified by a user of the portable terminal; and
the first apparatus comprising:
a second communication device; and
a second controller configured to:
control the second communication device to receive the first signal from the portable terminal;
based on the information included in the first signal, determine one of a plurality of second apparatuses located within a predetermined distance from the current location of the portable terminal and nearest to the destination; and
control the second communication device to transmit, to the determined second apparatus, a second signal that causes the second apparatus to transmit a beacon signal to the portable terminal,
wherein the portable terminal displays guidance information that guides the user toward the determined second apparatus based on the beacon signal received from the determined second apparatus.

2. The guidance system according to claim 1, wherein
the portable terminal acquires the information about the current location from a wireless tag.

3. The guidance system according to claim 2, wherein
the wireless tag is installed in one of the second apparatuses.

4. The guidance system according to claim 1, wherein
the first apparatus comprises a memory that stores information about a location of each of the second apparatuses, and
the second controller of the first apparatus is configured to
determine, based on the information stored in the memory, one or more of the second apparatuses located on a route from the current location of the portable terminal to the destination, and
control the second communication device to transmit the second signal to the one or more determined second apparatuses.

5. The guidance system according to claim 4, wherein
the first apparatus is configured to control the second communication device to transmit, to the portable terminal, information about the locations of the determined second apparatuses, and
the portable terminal displays the guidance information with information indicating the locations of the determined second apparatuses.

6. The guidance system according to claim 4, wherein
the second controller is configured to control the second communication device to transmit the second signal to one of the second apparatuses located nearest to the current location of the portable terminal.

7. The guidance system according to claim 1, wherein
the second signal transmitted from the first apparatus to the second apparatus includes an ID of the user,
the determined second apparatus transmits the beacon signal including the ID.

8. The guidance system according to claim 7, wherein
when receiving the beacon signal including the ID, the portable terminal displays the guidance information.

9. The guidance system according to claim 8, wherein
the portable terminal comprises an input device to input the ID and a memory to store the ID input by the user.

10. The guidance system according to claim 1, wherein
the portable terminal displays the guidance information based on a signal strength of the received beacon signal.

11. The guidance system according to claim 1, wherein
one of the second apparatuses is configured to communicate with the first apparatus via another second apparatus or a network.

12. A guidance system comprising:
a portable terminal comprising:
a first communication device; and
a first controller configured to
control the first communication device to transmit, to a first apparatus, a first signal including information about a current location of the portable terminal and a destination specified by a user of the portable terminal; and
the first apparatus comprising:
a second communication device;
a third communication device; and
a second controller configured to:
control the second communication device to receive the first signal from the portable terminal;
based on the information included in the first signal, determine one of a plurality of second apparatuses located within a predetermined distance from the current location of the portable terminal and nearest to the destination;
generate a first beacon signal that causes the determined second apparatus to transmit a second beacon signal to the portable terminal; and
control the third communication device to transmit the first beacon signal to the determined second apparatus,
wherein the portable terminal displays guidance information that guides the user toward the determined second apparatus based on the second beacon signal received from the determined second apparatus.

13. The guidance system according to claim 12, wherein
the first beacon signal includes an ID of the user and a location ID of the determined second apparatus.

14. The guidance system according to claim 13, wherein
when receiving the first beacon signal including the location ID, the determined second apparatus generates the second beacon signal including the ID of the user included in the first beacon signal and transmits the second beacon signal to the portable terminal.

15. The guidance system according to claim 14, wherein
when receiving the second beacon signal including the ID, the portable terminal displays the guidance information.

16. The guidance system according to claim 15, wherein
the portable terminal comprises an input device to input the ID and a memory to store the ID input by the user.

17. The guidance system according to claim 12, wherein
the first apparatus comprises a wireless tag, and
the portable terminal acquires the information about the current location from the wireless tag.

18. The guidance system according to claim 17, wherein
in response to a receipt of the information about the current location, the first controller of the portable terminal controls the first communication device to transmit the first signal to the first apparatus.

19. The guidance system according to claim 12, wherein
the portable terminal displays the guidance information based on a signal strength of the received second beacon signal.

20. An information processing apparatus configured to communicate with a portable terminal and a plurality of beacon transmitters, comprising:
a communication device; and
a controller configured to:
control the communication device to receive from the portable terminal a first signal including information about a current location of the portable terminal and a destination specified by a user of the portable terminal;
based on the information included in the first signal, determine one of the beacon transmitters located within a predetermined distance from the current location of the portable terminal and nearest to the destination; and
control the communication device to transmit, to the determined beacon transmitter, a second signal that causes the beacon transmitter to transmit a beacon signal for guiding the user to the beacon transmitter.
